(19) United States
(12) Patent Application Publication
(10) Pub. No.: US 2017/0339581 A1
(43) Pub. Date: Nov. 23, 2017

(54) HIGH-PERFORMANCE CONTENT RECONSTRUCTION OF MERGED AND REMOVED CELLS IN INTEGRATED CIRCUIT LAYOUT VERIFICATION PROCESS

(71) Applicant: Synopsys, Inc., Mountain View, CA (US)

(72) Inventors: Kevin Lee Macdonald, Sunnyvale, CA (US); Aydin Osman Balkan, Sunnyvale, CA (US)

(21) Appl. No.: 15/603,140

(22) Filed: May 23, 2017

Related U.S. Application Data
(60) Provisional application No. 62/340,477, filed on May 23, 2016.

(51) Int. Cl. H04W 24/02; H04W 16/32; H04W 16/24

(52) U.S. Cl. CPC H04W 24/02; H04W 16/24; H04W 16/32

(57) ABSTRACT

Various methods, apparatus, systems, and non-transitory computer-readable storage medium are provided for facilitating content reconstruction of merged and removed cells in an integrated circuit layout verification process. An example method comprises identifying one or more particular cells comprising original cell content requested by cell-specific operations, determining a set of cells of interest, the set of cells of interest comprised of the one or more particular cells identified as comprising original cell content requested by cell-specific operations, preserving original cell information from the set of cells of interest, and subsequently, performing a cell optimization phase, wherein the subsequent cell optimization phase comprises producing a set of geometric locations from a merger of the set of cells of interest into a set of merged cells, each geometric location being a physical location in a circuit layout represented by a node id or coordinates and processing a final set of cells.

### CROSS-REFERENCE TO RELATED APPLICATIONS

This application claims benefit under 35 USC 119 (e) of U.S. provisional Application No. 62/340,477, filed May 23, 2016, the entire content of which is incorporated herein by reference.

### TECHNOLOGICAL FIELD

Example embodiments of the present invention relate generally to integrated circuit design and, more particularly, to content reconstruction.

### BACKGROUND

Integrated circuit (IC) layouts are composed of “cells”. A cell contains data elements (e.g. geometric shapes), and references to other cells. Thus a layout is defined hierarchically; it contains a top cell, which has references to child cells, which in turn reference their own child cells, and so on. FIG. 1 illustrates an example cell hierarchy 100 with a top cell 110 that is a parent cell of child cells 120. However, child cells 120 are parent cells for child cells 130, which are also parent cells for child cells 140. In this example, there are six types of cells represented as cells A, B, C, D, E and F, each of which may be represented in any parent or child cell location. That is, a cell can be placed multiple times under different parent cells or even the same parent cell. This saves disk space because a cell's data only needs to be stored once, while it is represented in multiple places by a reference to the cell.

A layout verification tool (e.g., for a design rule check, or ‘DRC’) works on cells as a basic unit. Layout verification tools process data cell by cell. However, the cells as defined in the input hierarchy from the layout are typically not optimal for a layout verification tool (LVT) data processing. The performance of the tool depends on certain characteristics of these cells. The tool's performance may be improved by several optimization steps that include merging of some cells without changing final output. That is, the LVT can modify the input hierarchy in various ways to achieve better runtime and memory usage. One example is to remove a cell from the hierarchy and merge it with the cells that reference it, by copying its contents (data and cell references) to each location that the cell was placed. For example, if ‘C’ is removed from FIG. 1, then its data is copied once into ‘TOP’, once into ‘D’, and twice into ‘B’. These operations result in an optimized hierarchy (OH).

However, the customer may have constraints about cell-specific operations. That is, the DRC may involve the tool producing original content from certain cells. One problem is that requested content may not be accurately reproducible if the tool has merged these cells already for performance improvement. For example, only the original data from cell ‘C’ in FIG. 1 may be requested. If the LVT were to remove ‘C’, then the ‘C’s data cannot be differentiated from the data of the cells it was copied into, namely ‘TOP’, ‘D’, and ‘B’. In order to fulfill this requirement, the prior art solution is to prevent ‘C’ from being removed. That is, in prior solutions, when original content of cells is needed, the tool prevents optimizations related to those cells, effectively preserving them in their original state. This enables original content to be reproduced.

### BRIEF SUMMARY

Disclosed herein are processes to enable a verification tool to perform optimizations that merge and remove cells from memory, and later reproduce original content from the merged cell. New steps are added and modifications made to a conventional design verification optimization phase.

Prior to optimization, the process identifies cell-specific operations that request original contents of identified cells. The cells from these operations are accumulated to generate a list of cells of interest. Next, the process preserves a minimal subset of original information from these cells. During subsequent cell optimizations, when a cell of interest is merged into another cell, the geometric location of the merge is recorded. After optimization, the process continues processing a final set of cells that result from optimization, which may or may not include cells of interest. When an operation requests the contents of a merged cell, the original content is recreated and copied into appropriate geometric locations in final cells.

Cells may be merged as part of performance optimizations, without sacrificing the accurate reproduction of original content of the merged cells. This enables the optimization of cells for improved performance, while still producing original content for cells.

In some embodiments, a method for facilitating content reconstruction of merged and removed cells in an integrated circuit layout verification process may be provided, the method comprising identifying one or more particular cells comprising original cell content requested by cell-specific operations, determining a set of cells of interest, the set of cells of interest comprised of the one or more particular cells identified as comprising original cell content requested by cell-specific operations, and preserving original cell information from the set of cells of interest.

In some embodiments, the method my further comprise performing a subsequent cell optimization phase, wherein the subsequent cell optimization phase comprises producing a set of geometric locations from a merger of the set of cells of interest into a set of merged cells, each geometric location being a physical location in a circuit layout represented by a node id or coordinates, and processing a final set of cells resulting from the cell optimization phase.

In some embodiments, the subsequent cell optimization phase further comprises, subsequent to the preservation of the original cell information from the set of the cells of interest, merging the original cell information from a particular cell into a cell referencing the particular cell, and removing the one or more particular cells.

In some embodiments, the method my further comprise, in an instance in which one of the cell-specific operations request content of a merged cell from the set of merged cells, recreating the original cell content for cell components of the merged cell from the original cell information, and copying the original cell content into a corresponding geometric location for the merged cell in a set of final cells, the corresponding geometric location identified from the set of geometric locations.

In some embodiments, the preservation of the subset of original cell information from the set of cells of interest comprises generating a shadow hierarchy. In some embodiments, generation of the shadow hierarchy comprises, for each cell from the set of cells of interest, the set of cells of interest comprised of the one or more particular cells identified as comprising original cell content requested by cell-specific operations, adding a copy of the cell to the shadow hierarchy, and for each descendent of each cell from the set of cells of interest, adding a copy of the descendent to the shadow hierarchy. In some embodiments, the method my further comprise generating a placement table, the placement table comprised of the set of final cells and, for each member of the set of final cells, the merged placements.

In some embodiments, a system may be provided for facilitating content reconstruction of merged and removed cells in an integrated circuit layout verification process, the system comprising a filter to identify one or more particular cells comprising original cell content requested by cell-specific operations, an accumulator to collect a set of cells of interest, the set of cells of interest comprised of the one or more particular cells identified as comprising original cell content requested by cell-specific operations, and a memory to preserve a subset of original cell information from the set of cells of interest.

In some embodiments, the system may further comprise a processor for performing a subsequent cell optimization phase, wherein the processor configured to perform the subsequent cell optimization phase comprises a geo-locator to generate a set of geometric locations from a merger of the set of cells of interest into a set of merged cells, each geometric location being a physical location in a circuit layout represented by a node id or coordinates, processing a final set of cells resulting from the cell optimization phase.

In some embodiments, the subsequent cell optimization phase further comprises, subsequent to the preservation of the original cell information from the set of the cells of interest, merging the original cell information from a particular cell into a cell referencing the particular cell, and removing the one or more particular cells.

In some embodiments, the system may further comprise, in an instance in which one of the cell-specific operations request content of a merged cell from the set of merged cells, a processor to extract, from the memory, the original cell content, recreating the original cell content for cell components of the merged cell from the original cell information, and to copy the original cell content into a corresponding geometric location for the merged cell in a set of final cells, the corresponding geometric location identified from the set of geometric locations.

In some embodiments, the preservation of the subset of original cell information from the set of cells of interest comprises generating a shadow hierarchy. In some embodiments, generation of the shadow hierarchy comprises, for each cell from the set of cells of interest, the set of cells of interest comprised of the one or more particular cells identified as comprising original cell content requested by cell-specific operations, adding a copy of the cell to the shadow hierarchy, and for each descendent of each cell from the set of cells of interest, adding a copy of the descendent to the shadow hierarchy. In some embodiments, the system may further comprise generating a placement table, the placement table comprised of the set of final cells and, for each member of the set of final cells, the merged placements.

In some embodiments, a non-transitory computer-readable storage medium may be provided for facilitating content reconstruction of merged and removed cells in an integrated circuit layout verification process, the computer-readable storage medium including instructions that when executed by one or more computer, cause the one or more computer to identify one or more particular cells comprising original cell content requested by cell-specific operations, determine a set of cells of interest, the set of cells of interest comprised of the one or more particular cells identified as comprising original cell content requested by cell-specific operations, and preserve original cell information from the set of cells of interest.

In some embodiments, the non-transitory computer-readable storage medium may further comprise instructions that when executed by one or more computer, cause the one or more computer to perform a subsequent cell optimization phase, wherein the subsequent cell optimization phase comprises producing a set of geometric locations from a merger of the set of cells of interest into a set of merged cells, each geometric location being a physical location in a circuit layout represented by a node id or coordinates, and processing a final set of cells resulting from the cell optimization phase.

In some embodiments, the subsequent cell optimization phase further comprises subsequent to the preservation of the original cell information from the set of the cells of interest, merging the original cell information from a particular cell into a cell referencing the particular cell, and removing the one or more particular cells.

In some embodiments, the non-transitory computer-readable storage medium may further comprise instructions that when executed by one or more computer, cause the one or more computer to in an instance in which one of the cell-specific operations request content of a merged cell from the set of merged cells, recreate the original cell content for cell components of the merged cell from the original cell information, and copy the original cell content into a corresponding geometric location for the merged cell in a set of final cells, the corresponding geometric location identified from the set of geometric locations.

In some embodiments, the preservation of the subset of original cell information from the set of cells of interest comprises generating a shadow hierarchy. In some embodiments generation of the shadow hierarchy comprises, for each cell from the set of cells of interest, the set of cells of interest comprised of the one or more particular cells identified as comprising original cell content requested by cell-specific operations, adding a copy of the cell to the shadow hierarchy, and for each descendent of each cell from the set of cells of interest, adding a copy of the descendent to the shadow hierarchy. In some embodiments, the non-transitory computer-readable storage medium may further comprise instructions that when executed by one or more computer, cause the one or more computer to generate a placement table, the placement table comprised of the set of final cells and, for each member of the set of final cells, the merged placements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example cell hierarchy 100.

FIG. 2 is a block diagram of a machine system 200 that may be specifically configured in accordance with an example embodiment of the present invention.

FIG. 3 is a block diagram of a cell processing system 300 that may be specifically configured in accordance with an example embodiment of the present invention.

FIGS. 4A-4C show a process 400 that may be performed by an example apparatus in accordance with an embodiment of the present invention.

FIG. 5 is an example flowchart 500 showing a method of operating an example apparatus in accordance with an embodiment of the present invention.

FIG. 6 is a block diagram of a computer system 600 that may be specifically configured in accordance with an example embodiment of the present invention.

FIG. 7 is an example flowchart 700 showing a method of operating an example apparatus in accordance with an embodiment of the present invention; and

FIG. 8 is a block diagram 800 of an apparatus that may be specifically configured in accordance with an example embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

“Cell” in this context refers to a group of transistor and interconnect structures that provides a building-block logic function (e.g., AND, OR, XOR, XNOR, inverters, flip-flop, latch, adder) of a machine circuit. That is, the cell is an object in a layout that contains data in the form of polygons and text, and references to other cells.

“Cells of Interest” in this context are a set of cells for which the tool is instructed to produce the contents as a result.

“Cell Extents” in this context is a bounding box that encompasses all of a cell's data elements and all of the child cell references placed within it.

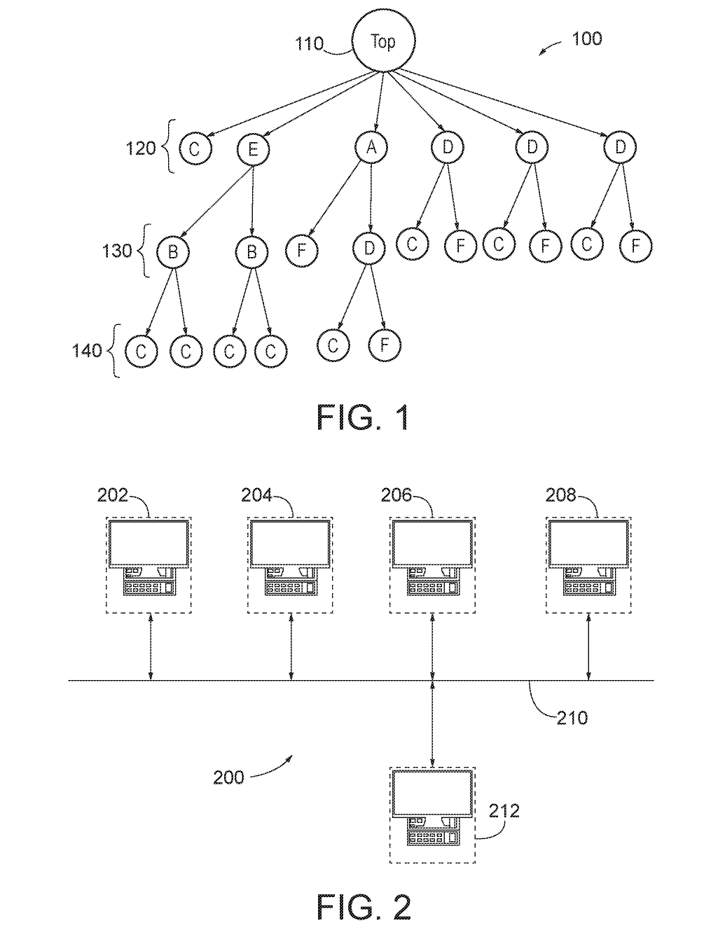

“Descendant Cell” in this context is a cell which is a descendant of a second cell if it is referenced within the second cell, either directly or indirectly. In FIG. 1 above, the descendants of ‘E’ are ‘B’ and ‘C’.

“DRC” in this context refers to ‘design rule check’, a validation executed on a layout view to verify that the layout meets foundry and other requirements.

“Geometric location” in this context refers to a physical location in a circuit layout as represented for example by a node id, or coordinates.

“Hierarchy” in this context is a collection of cells, with one or more top cells. It is analogous to a directed acyclic graph with vertices being cells, and edges being cell references.

“Layout” in this context refers to the physical design representation of a circuit. From a manufacturing perspective, the layout view may be closest to an actual manufacturing blueprint of the circuit. The layout view may be organized into base layers, which correspond to the different devices in the circuit, and interconnect wiring layers and via layers, which join together the terminals of the different devices. Non-manufacturing layers may be also be present in a layout for purposes of design automation.

“Merge and Remove” in this context is the removal of all placements of a cell from a hierarchy and a merging of the cell's data contents into each location of removal in the parent cell(s). The removed cell is not present in the layout after this operation.

“Merged cell” in this context refers to a cell resulting from the merger of the circuit elements and characteristics of component cells.

“Netlist” in this context refers to a nodal description of transistors in a circuit, of their connections to each other, and of their terminals (ports) to the external environment of a circuit.

“Optimized Hierarchy” (OH) in this context is a final hierarchy after applying a sequence of merge and remove operations.

“Original cell content” in this context refers to physical and/or operational characteristics of a cell prior to combining/merging the cell into a combined structure in a layout verification process.

“Removed Placement” in this context is a placeholder indicating where a placement of one cell merged into another.

“Shadow Cell” in this context is a copy of an original input layout cell.

“Shadow Hierarchy” (SH) in this context a hierarchy containing all shadow cells.

“Top Cell” in this context is a cell that is not referenced by any other cell.

FIG. 2 illustrates a machine system 200 to implement a cell optimization process in accordance with one embodiment. Exemplary machine system 200 includes four workstations (workstation 202, workstation 204, workstation 206 and workstation 208) and a master station (workstation 212) to allocate and manage a distributed cell optimization process on the workstations in the system. Machine system 200 implements what is commonly called a computer cluster.

A computer cluster comprises of a set of communicatively coupled computers that work together so that, in many respects, they can be viewed as a single system. The components of a cluster are usually coupled to each other through fast local or wide area networks, with each node (e.g., workstation) executing its own instance of an operating system. In most circumstances, all of the nodes use the same hardware and the same operating system, although in some setups (i.e. using Open Source Cluster Application Resources (OSCAR)), different operating systems can be used on each computer, and/or different hardware.

Computer clusters are utilized to improve performance and availability over that of a single computer, while typically being more cost-effective than single computers of comparable speed or availability.

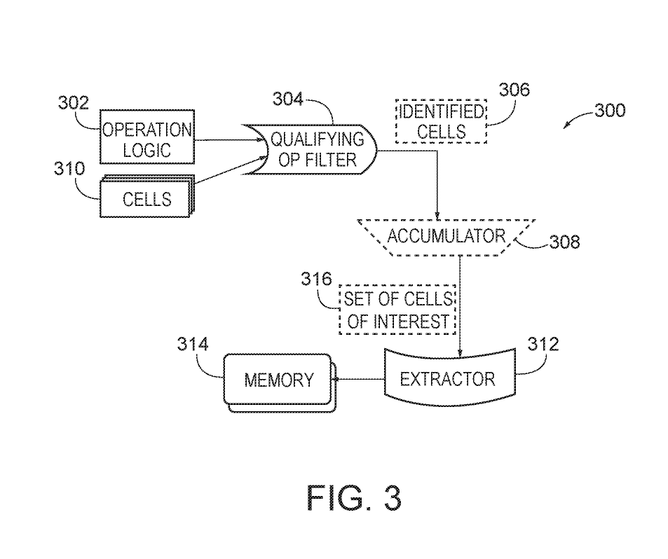

Referring to FIG. 3, a cell processing system 300 comprises operation logic 302, qualifying op filter 304, accumulator 308, extractor 312, and memory 314. These components are operated together on cells 310 to identify cell-specific operations that request original cell content of identified cells 306, to accumulate the identified cells into a set of cells of interest 316, and to preserve a subset of original cell information from the set of cells of interest 316 in memory 314.

Given a layout, cell processing system 300 performs an arbitrary number of merge and remove operations resulting in a final optimized hierarchy where some cells are not present anymore. When the tool is requested to produce content or extents of a set of cells S={C₁, C₂, . . . }, it must return the requested data regardless of presence of these cells in the final hierarchy. That is, with reference to FIG. 1, an embodiment of the invention allows ‘C’ to be merged and removed while still being able to recreate data based on ‘C’. This is achieved by introducing a shadow hierarchy (SH) that contains the necessary original cells like ‘C’. Additional accounting mechanisms are needed to correlate between the OH and SH.

LVT can achieve optimal runtime and memory goals without being constrained by cell-specific operations required by the user. Allowing LVT to remove undesired cells even if they are need for data selection or construction purposes benefits LVT runtime. The reason behind this is that many of LVT's algorithms are not purely cell-level. The correct answer may not be solvable if some of the data within a cell interacts with data in a parent cell. Therefore, LVT removes small cells up to a point that the remaining cells are of a reasonable size such that there is a decent sized workload of solvable data within the cell.

A method to reconstruct data from removed cells can have four major components. In a first component, a minimal copy of portions of the layout hierarchy are kept in a “shadow hierarchy”. In a second component, all of the cell placements that have been removed are tracked. In a third component, a mapping between cells in the optimized hierarchy and their corresponding shadow cell is maintained. In a fourth component, the original contents of cells as requested by the user are produced.

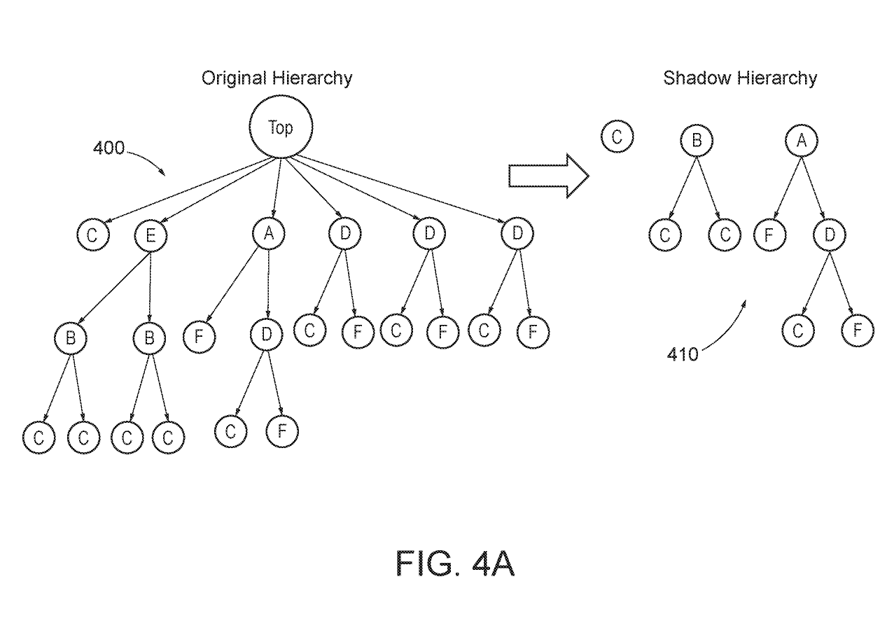

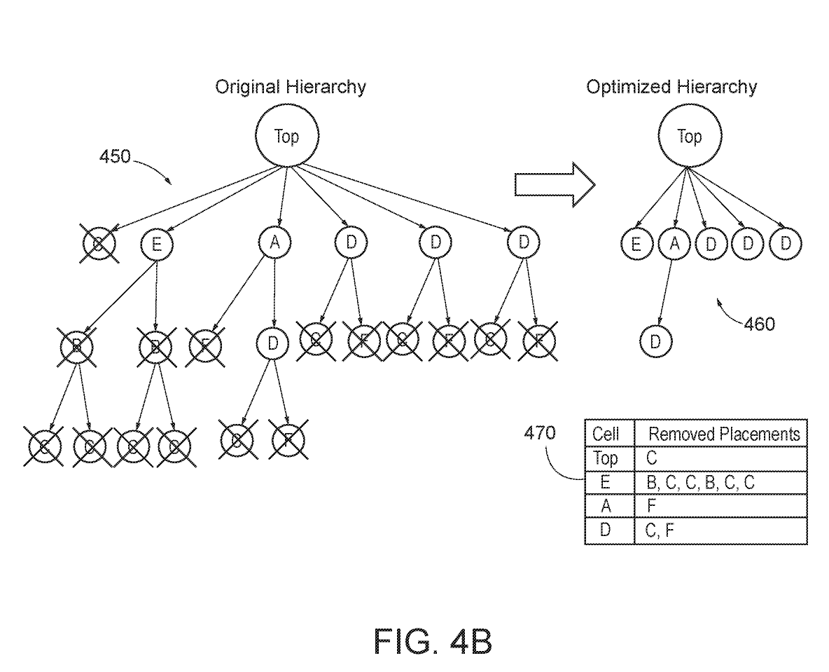

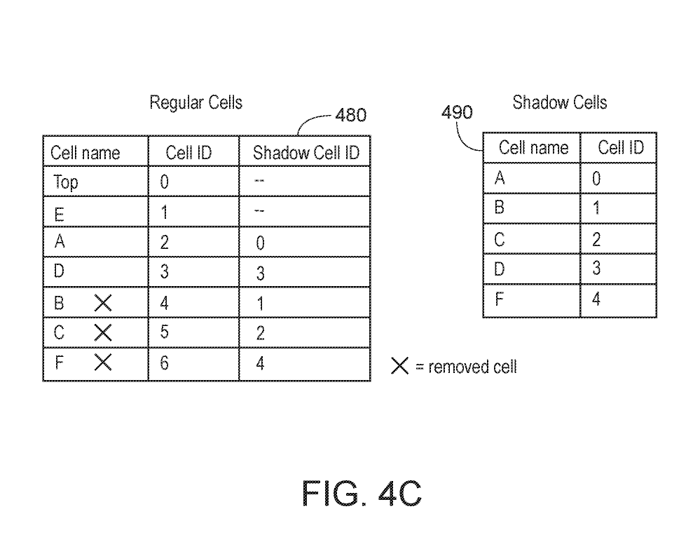

FIGS. 4A through 4C illustrate the use of a shadow hierarchy for storing portions of the layout hierarchy. The purpose of the shadow hierarchy is to preserve the original state of some selected set of cells of interest, S. The tool generates S by identifying all cell-specific operations that request original content from cells, and adding the requested cells to S. Shadow hierarchy creation occurs before any hierarchy transformations. Descendant cells must be included in the shadow hierarchy since requested content may include content of descendants. Shadow hierarchy works as follows:

for each cell X in S:
add copy of X to shadow_hierarchy
for each descendant Y of X:
   add copy of Y to shadow_hierarchy

FIG. 4A illustrates the resulting shadow hierarchy from FIG. 1 if S={A, B, C}. That is, the original content of cells A, B and C need to be preserved for future use after any merge and delete processes during hierarchy optimization. Original hierarchy 400 previously described in FIG. 1 is shown with shadow hierarchy 410 derived from the original hierarchy containing the original content of cells A, B and C, including any descendent cells.

After generation of the shadow hierarchy, the main hierarchy is optimized. Every placement of a cell that is merged into its parent and deleted must be tracked. 4B illustrates original hierarchy 450 previously described in FIGS. 1 and 4A above with crossed out placements based on the process described herein. Also shown in FIG. 4B is an optimized hierarchy 460, along with the removed placement table 470 showing what placements merged into each cell that remains in the hierarchy.

FIG. 4C illustrates a shadow cell map supporting the preservation of the original content of cells A, B and C during the merge and delete optimization process. A mapping must be maintained between cells in the regular hierarchy and the shadow hierarchy. Cells in a hierarchy can be tracked with unique numerical identifiers. The mapping can be represented as a table with entries for each cell, and its numerical identifier in each hierarchy.

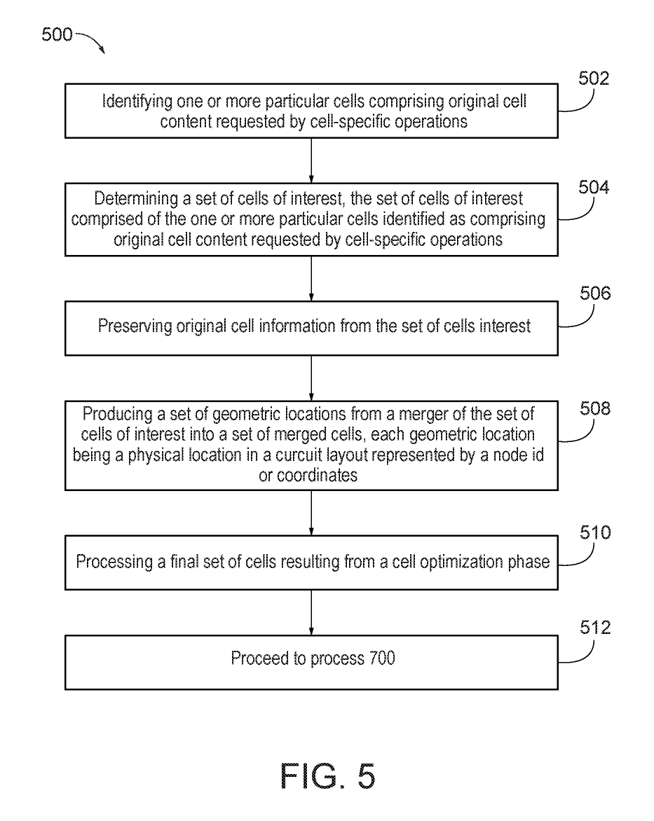

FIG. 5 is a flowchart showing an exemplary embodiment of a process of operating an example apparatus or system, for example, the cell processing system 300, in accordance with an embodiment of the present invention. Specifically FIG. 5 shows an example method for facilitating content reconstruction of merged and removed cells in an integrated circuit layout verification process.

Initially, cell-specific operations are identified that request original cell content of identified cells. Accordingly, as shown in block 502 of FIG. 5, the apparatus 300 or 800 may be configured to identify one or more particular cells comprising original cell content requested by cell-specific operations. The apparatus 300 or 800 may therefore include means, such as a processor 810 or operation logic 302 or the like, for identifying one or more particular cells comprising original cell content requested by cell-specific operations.

Next, the identified cells are accumulated into a set of cells of interest. As such, as shown in block 504 of FIG. 5, the apparatus 300 or 800 may be configured to determine a set of cells of interest. In some embodiments, the set of cells of interest may be comprised of the one or more particular cells identified as comprising original cell content requested by cell-specific operations. The apparatus 300 or 800 may therefore include means, such as a processor 810 or operation logic 302 or the like, for determining a set of cells of interest.

In some embodiments, a subset of original cell information from the set of cells of interest may then be preserved, for example, in a shadow hierarchy as illustrated with reference to FIG. 4A above. Accordingly, as shown in block 506 of FIG. 5, the apparatus 300 or 800 may be configured to preserve original cell information from the set of cells of interest. The apparatus 300 or 800 may therefore include means, such as a processor 810 or operation logic 302 or the like, for preserving original cell information from the set of cells of interest. In some embodiments, the preservation of the subset of original cell information from the set of cells of interest comprises: generating a shadow hierarchy. Generation of the shadow hierarchy may comprise, for each cell from the set of cells of interest, the set of cells of interest comprised of the one or more particular cells identified as comprising original cell content requested by cell-specific operations, adding a copy of the cell to the shadow hierarchy, and, for each descendent of each cell from the set of cells of interest, adding a copy of the descendent to the shadow hierarchy.

Subsequently, for example, during a subsequent cell optimization phase as illustrated with reference to FIG. 4B, a set of geometric locations may be produced from a merger of the set of cells of interest. As such, for example, during the subsequent cell optimization phase, as shown in block 508 of FIG. 5, the apparatus 300 or 800 may be configured to produce a set of geometric locations from a merger of the set of cells of interest into a set of merged cells, each geometric location being a physical location in a circuit layout represented by a node id or coordinates. The apparatus 300 or 800 may therefore include means, such as a processor 810 or operation logic 302 or the like, for producing a set of geometric locations from a merger of the set of cells of interest into a set of merged cells, each geometric location being a physical location in a circuit layout represented by a node id or coordinates.

Then a set of final cells may then be processed from the cell optimization phase as illustrated with reference to FIG. 4C. Accordingly, as shown in block 510 of FIG. 5, the apparatus 300 or 800 may be configured to process a final set of cells resulting from the cell optimization phase. The apparatus 300 or 800 may therefore include means, such as a processor 810 or operation logic 302 or the like, for processing a final set of cells resulting from the cell optimization phase.

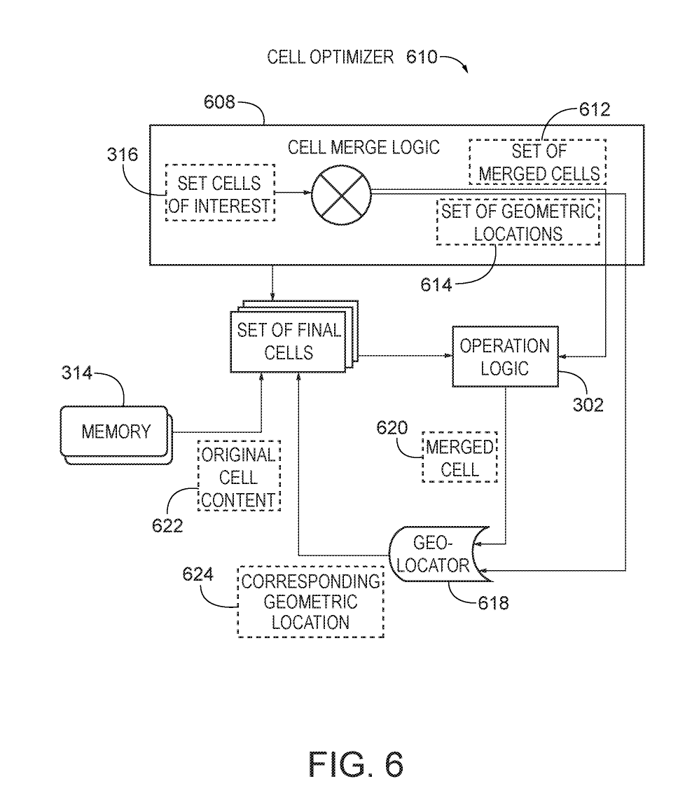

Referring now to FIG. 6, cell processing system 300 further comprises a cell optimizer 610 comprising cell merge logic 608 that operates on the set of cells of interest 616. The cell merge logic 608 transforms the set of cells of interest 616 into a set of merged cells 612 and a set of geometric locations 614. Overall, the cell optimizer 610 produces a set of final cells 616 which includes the set of merged cells 612.

Cell processing system 300 further comprises a geo-locator 618 that operates in conjunction with operation logic 302. The set of final cells 616 from the cell optimizer 610, the set of merged cells 612, and the set of geometric locations 614 are all applied to the operation logic 302 which among other things performs one or more cell-specific operation on a merged cell 620 of the set of merged cells 612. The cell-specific operation on the merged cell 620 may utilize original cell content 622, in which case the geo-locator 618 operates on the set of geometric locations 614 to generate a corresponding geometric location 624 for the merged cell 620. The original cell content 622 for one or more cell components of the merged cell is located in the memory 314 and written back to the corresponding geometric location 624 of the set of final cells 616.

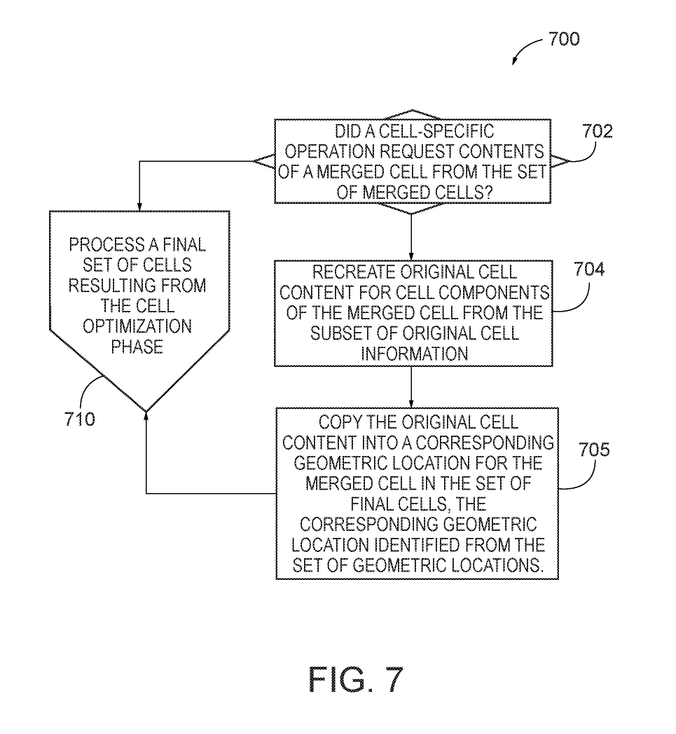

FIG. 7 is a flowchart showing an exemplary embodiment of a process to operate, for example, the cell processing system 300, in accordance with an embodiment of the present invention. Specifically FIG. 7 shows an example method for facilitating content reconstruction of merged and removed cells in an integrated circuit layout verification process.

First, a test is performed. As such, as shown in block 702 of FIG. 7, the apparatus 300 or 800 may be configured to identify whether a cell-specific operation request contents of a merged cell from the set of merged cells. The apparatus 300 or 800 may therefore include means, such as a processor 810 or operation logic 302 or the like, for identifying whether a cell-specific operation request contents of a merged cell from the set of merged cells.

In an instance in which one of the cell-specific operations requested content of a merged cell from the set of merged cells, the process moves to block 704. As shown in block 704 of FIG. 7, the apparatus 300 or 800 may be configured to recreate the original cell content for cell components of the merged cell from the original cell information. The apparatus 300 or 800 may therefore include means, such as a processor 810 or operation logic 302 or the like, for recreating the original cell content for cell components of the merged cell from the original cell information.

The original cell content may then be copied (e.g., written) into a corresponding geometric location for the merged cell in the set of final cells. As such, as shown in block 706 of FIG. 7, the apparatus 300 or 800 may be configured to copy the original cell content into a corresponding geometric location for the merged cell in a set of final cells, the corresponding geometric location identified from the set of geometric locations. The apparatus 300 or 800 may therefore include means, such as a processor 810 or operation logic 302 or the like, for copying the original cell content into a corresponding geometric location for the merged cell in a set of final cells, the corresponding geometric location identified from the set of geometric locations.

Returning to the determination at block 702, in an instance in which one of the cell-specific operations does not or did not request content of a merged cell from the set of merged cells, the process moves to block 708. As shown in block 708 of FIG. 7, the apparatus 300 or 800 may be configured to XYZ. The apparatus 300 or 800 may therefore include means, such as a processor 810 or operation logic 302 or the like, for XYZ.

As shown in block 710 of FIG. 7, the apparatus 300 or 800 may be configured to process the final set of cells resulting from the cell optimization phase. The apparatus 300 or 800 may therefore include means, such as a processor 810 or operation logic 302 or the like, for processing the final set of cells resulting from the cell optimization phase.

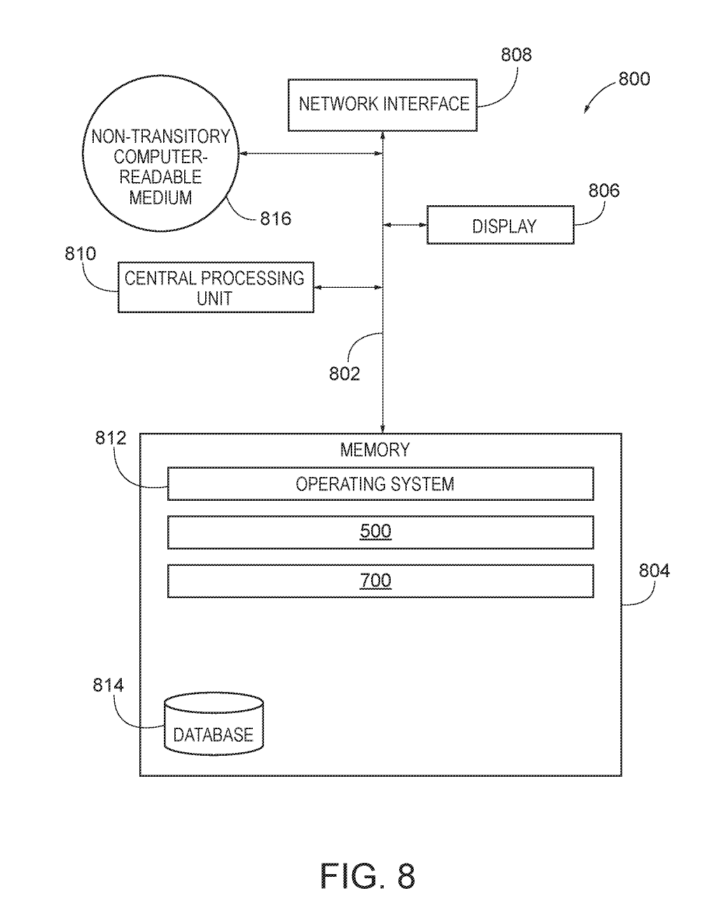

FIG. 8 illustrates several components of an exemplary computer system 800 in accordance with one embodiment. In various embodiments, computer system 800 may include a desktop PC, server, workstation, mobile phone, laptop, tablet, set-top box, appliance, or other computing device that is capable of performing operations such as those described herein. In some embodiments, computer system 800 may include many more components than those shown in FIG. 8. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, computer system 800 may comprise one or more physical and/or logical devices that collectively provide the functionalities described herein. In some embodiments, computer system 800 may comprise one or more replicated and/or distributed physical or logical devices.

In some embodiments, computer system 800 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Computer system 800 includes a bus 802 interconnecting several components including a network interface 808, a display 806, a central processing unit 810, and a memory 804.

Memory 804 generally comprises a random access memory (“RAM”) and permanent non-transitory mass storage device, such as a hard disk drive or solid-state drive. Memory 804 stores an operating system 812. Memory 804 can also include software for implementing processes 500 and 700 described above.

These and other software components may be loaded into memory 804 of computer system 800 using a drive mechanism (not shown) associated with a non-transitory computer-readable medium 816, such as a floppy disc, tape, DVD/CD-ROM drive, memory card, or the like.

Memory 804 also includes database 814. In some embodiments, computer system 800 may communicate with database 814 via network interface 808, a storage area network (“SAN”), a high-speed serial bus, and/or via the other suitable communication technology.

In some embodiments, database 814 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation. Those having skill in the art will appreciate that there are various logic implementations by which processes and/or systems described herein can be effected (e.g., hardware, software, and/or firmware), and that the preferred vehicle will vary with the context in which the processes are deployed.

“Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment). Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

FIGS. 5 and 7, described above, illustrate example flowcharts of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 5 and 7, when executed, convert a computer or processing circuitry into a particular machine configured to perform an example embodiment of the present invention. Accordingly, the operations of FIGS. 5 and 7 define an algorithm for configuring a computer or processing to perform an example embodiment. In some cases, a general purpose computer may be provided with an instance of the processor which performs the algorithms of FIGS. 5 and 7 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified. Moreover, in some embodiments additional optional operations may also be included. It should be appreciated that each of modification, optional addition or amplification may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for facilitating content reconstruction of merged and removed cells in an integrated circuit layout verification process, the method comprising:
identifying one or more particular cells comprising original cell content requested by cell-specific operations;
determining a set of cells of interest, the set of cells of interest comprised of the one or more particular cells identified as comprising original cell content requested by cell-specific operations; and
preserving original cell information from the set of cells of interest.

2. The method of claim 1, further comprising:
performing a subsequent cell optimization phase, wherein the subsequent cell optimization phase comprises:
producing a set of geometric locations from a merger of the set of cells of interest into a set of merged cells, each geometric location being a physical location in a circuit layout represented by a node id or coordinates; and
processing a final set of cells resulting from the cell optimization phase.

3. The method of claim 2, wherein the subsequent cell optimization phase further comprises:
subsequent to the preservation of the original cell information from the set of the cells of interest, merging the original cell information from a particular cell into a cell referencing the particular cell; and
removing the one or more particular cells.

4. The method of claim 2, further comprising:
in an instance in which one of the cell-specific operations request content of a merged cell from the set of merged cells,
recreating the original cell content for cell components of the merged cell from the original cell information; and
copying the original cell content into a corresponding geometric location for the merged cell in a set of final cells, the corresponding geometric location identified from the set of geometric locations.

5. The method of claim 1, wherein the preservation of the subset of original cell information from the set of cells of interest comprises: generating a shadow hierarchy.

6. The method of claim 4, wherein generation of the shadow hierarchy comprises:
for each cell from the set of cells of interest, the set of cells of interest comprised of the one or more particular cells identified as comprising original cell content requested by cell-specific operations, adding a copy of the cell to the shadow hierarchy; and
for each descendent of each cell from the set of cells of interest, adding a copy of the descendent to the shadow hierarchy.

7. The method according to claim 6, further comprising:
generating a placement table, the placement table comprised of the set of final cells and, for each member of the set of final cells, the merged placements.

8. A system for facilitating content reconstruction of merged and removed cells in an integrated circuit layout verification process, the system comprising:
a filter to identify one or more particular cells comprising original cell content requested by cell-specific operations;
an accumulator to collect a set of cells of interest, the set of cells of interest comprised of the one or more particular cells identified as comprising original cell content requested by cell-specific operations; and
a memory to preserve a subset of original cell information from the set of cells of interest.

9. The system of claim 8, further comprising:
a processor for performing a subsequent cell optimization phase, wherein the subsequent cell optimization phase comprises:
a geo-locator to generate a set of geometric locations from a merger of the set of cells of interest into a set of merged cells, each geometric location being a physical location in a circuit layout represented by a node id or coordinates;
processing a final set of cells resulting from the cell optimization phase.

10. The system of claim 9, wherein the subsequent cell optimization phase further comprises:
subsequent to the preservation of the original cell information from the set of the cells of interest, merging the original cell information from a particular cell into a cell referencing the particular cell; and
removing the one or more particular cells.

11. The system of claim 9, in an instance in which one of the cell-specific operations request content of a merged cell from the set of merged cells, the system further comprising:
a processor to extract, from the memory, the original cell content, recreating the original cell content for cell components of the merged cell from the original cell information; and to copy the original cell content into a corresponding geometric location for the merged cell in a set of final cells, the corresponding geometric location identified from the set of geometric locations.

12. The system of claim 8, wherein the preservation of the subset of original cell information from the set of cells of interest comprises: generating a shadow hierarchy.

13. The system of claim 12, wherein generation of the shadow hierarchy comprises:
for each cell from the set of cells of interest, the set of cells of interest comprised of the one or more particular cells identified as comprising original cell content requested by cell-specific operations, adding a copy of the cell to the shadow hierarchy; and
for each descendent of each cell from the set of cells of interest, adding a copy of the descendent to the shadow hierarchy.

14. The system according to claim 13, further comprising:
generating a placement table, the placement table comprised of the set of final cells and, for each member of the set of final cells, the merged placements.

15. A non-transitory computer-readable storage medium for facilitating content reconstruction of merged and removed cells in an integrated circuit layout verification process, the computer-readable storage medium including instructions that when executed by one or more computer, cause the one or more computer to:
identify one or more particular cells comprising original cell content requested by cell-specific operations;
determine a set of cells of interest, the set of cells of interest comprised of the one or more particular cells identified as comprising original cell content requested by cell-specific operations; and
preserve original cell information from the set of cells of interest.

16. The non-transitory computer-readable storage medium of claim 15, further comprising instructions that when executed by one or more computer, cause the one or more computer to:
perform a subsequent cell optimization phase, wherein the subsequent cell optimization phase comprises:
producing a set of geometric locations from a merger of the set of cells of interest into a set of merged cells, each geometric location being a physical location in a circuit layout represented by a node id or coordinates; and
processing a final set of cells resulting from the cell optimization phase.

17. The non-transitory computer-readable storage medium of claim 16, wherein the subsequent cell optimization phase further comprises:
subsequent to the preservation of the original cell information from the set of the cells of interest, merging the original cell information from a particular cell into a cell referencing the particular cell; and
removing the one or more particular cells.

18. The non-transitory computer-readable storage medium of claim 16, further comprising instructions that when executed by one or more computer, cause the one or more computer to:
in an instance in which one of the cell-specific operations request content of a merged cell from the set of merged cells,
recreate the original cell content for cell components of the merged cell from the original cell information; and
copy the original cell content into a corresponding geometric location for the merged cell in a set of final cells, the corresponding geometric location identified from the set of geometric locations.

19. The non-transitory computer-readable storage medium of claim 15,
wherein the preservation of the subset of original cell information from the set of cells of interest comprises: generating a shadow hierarchy.

20. The non-transitory computer-readable storage medium of claim 18, wherein generation of the shadow hierarchy comprises:
for each cell from the set of cells of interest, the set of cells of interest comprised of the one or more particular cells identified as comprising original cell content requested by cell-specific operations, adding a copy of the cell to the shadow hierarchy; and
for each descendent of each cell from the set of cells of interest, adding a copy of the descendent to the shadow hierarchy.

21. The non-transitory computer-readable storage medium according to claim 20, further comprising instructions that when executed by one or more computer, cause the one or more computer to:
generate a placement table, the placement table comprised of the set of final cells and, for each member of the set of final cells, the merged placements.
